(19) United States
(12) Patent Application Publication
(10) Pub. No.: US 2003/0090713 A1
(43) Pub. Date: May 15, 2003

(54) Print system, control method thereof, and print management apparatus and method

(76) Inventor: Kazuyuki Saito, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/237,881

(22) Filed: Sep. 10, 2002

(30) Foreign Application Priority Data
Sep. 13, 2001 (JP) 2001-278599

(51) Int. Cl. B41J 1/00; G06F 15/00

(52) U.S. Cl. 358/1.15

(57) ABSTRACT

In a print system having a plurality of printers, when print data and a print instruction related to print control of the print data are input, a job ticket generating section generates a job ticket on the basis of the print instruction. A print information control section causes a direct instruction generating section to generate a direct instruction to partially change instruction contents by the job ticket if a printer selected from the plurality of printers cannot execute processing requested by the instruction information. A print server executes printing of the print data in accordance with the job ticket and direct instruction using the selected printer.

### FIELD OF THE INVENTION

The present invention relates to a print system which outputs print information using a job ticket as a print instruction for processing, display, or printing, an print management apparatus, and methods thereof.

### BACKGROUND OF THE INVENTION

Conventionally, as methods of controlling printing by a plurality of printing devices, a system having a print manager for processing routing or a processing instruction of a job ticket, as in Japanese Patent Laid-Open No. 05-216606, a system having an “agent” in a print server, as in Japanese Patent Laid-Open No. 09-179833, and a system which records a result representing a page and a printer to which the page was output after print processing, as in Japanese Patent Laid-Open No. 10-198533, have been proposed.

However, the above systems proposed have the following problems.

Japanese Patent Laid-Open No. 05-216606

(1) The print manager does not process print data itself, and identification and processing of a print instruction itself in a job ticket are done on a device side. For this reason, printing cannot be reliably executed for some job ticket contents.

Japanese Patent Laid-Open No. 09-179833

(1) When an agent can determine in advance that processing is impossible, a corresponding job ticket is entirely transferred to the next agent. This cannot not cope with an error that has occurred midway during printing. If an error has occurred midway during printing, the print result becomes imperfect.

(2) When substitute print processing is necessary because of the ability or a trouble in a printer, the substitute printer is selected by the agent. Hence, the user cannot always make a desired substitute printer to execute printing.

Japanese Patent Laid-Open No. 10-198533

(1) Only a result representing a page and a printer to which the printer was output is recorded. Hence, if a target printer has an error, printing cannot be completed because, e.g., it lacks a page that should be printed by the target printer.

### SUMMARY OF THE INVENTION

The present invention has been made in consideration of the above problems, and has as its object to make it possible to execute substitute printing using devices having different abilities, reduce use limitation of devices in a system, and efficiently use devices on a network.

According to the present invention, the foregoing object is attained by providing a print system having a plurality of printers, comprising:

input means for inputting print data and a print instruction related to print control of the print data;

generation means for generating instruction information on the basis of the print instruction;

selection means for selecting one of the plurality of printers on the basis of the instruction information; and

change means for partially changing contents instructed by the instruction information if the selected printer cannot execute processing requested by the instruction information.

According to another aspect of the present invention, the foregoing object is attained by providing a print method using a plurality of printers, comprising:

the input step of inputting print data and a print instruction related to print control of the print data;

the generation step of generating instruction information on the basis of the print instruction;

the selection step of selecting one of the plurality of printers on the basis of the instruction information; and

the change step of partially changing contents instructed by the instruction information if the selected printer cannot execute processing requested by the instruction information.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing the arrangement of a print system according to the first embodiment;

FIG. 2 is a flow chart for explaining print processing by the first embodiment;

FIG. 3 is a flow chart showing job ticket generation processing;

FIG. 4 is a flow chart for explaining print processing by the second embodiment;

FIG. 5 is a flow chart for explaining print processing by the second embodiment;

FIG. 6 is a block diagram showing the arrangement of a print system according to the third embodiment;

FIG. 7 is a flow chart for explaining print processing by the third embodiment;

FIG. 8 is a flow chart showing secondary job ticket generation processing;

FIG. 9 is a flow chart for explaining print processing by the fourth embodiment;

FIG. 10 is a flow chart for explaining print processing by the fourth embodiment; and

FIG. 11 is a flow chart showing job ticket initialization processing.

### DETAILED DESCRIPTION OF THE PREFERRED EMBODIMENTS

Preferred embodiments of the present invention will now be described in detail in accordance with the accompanying drawings.

<First Embodiment>

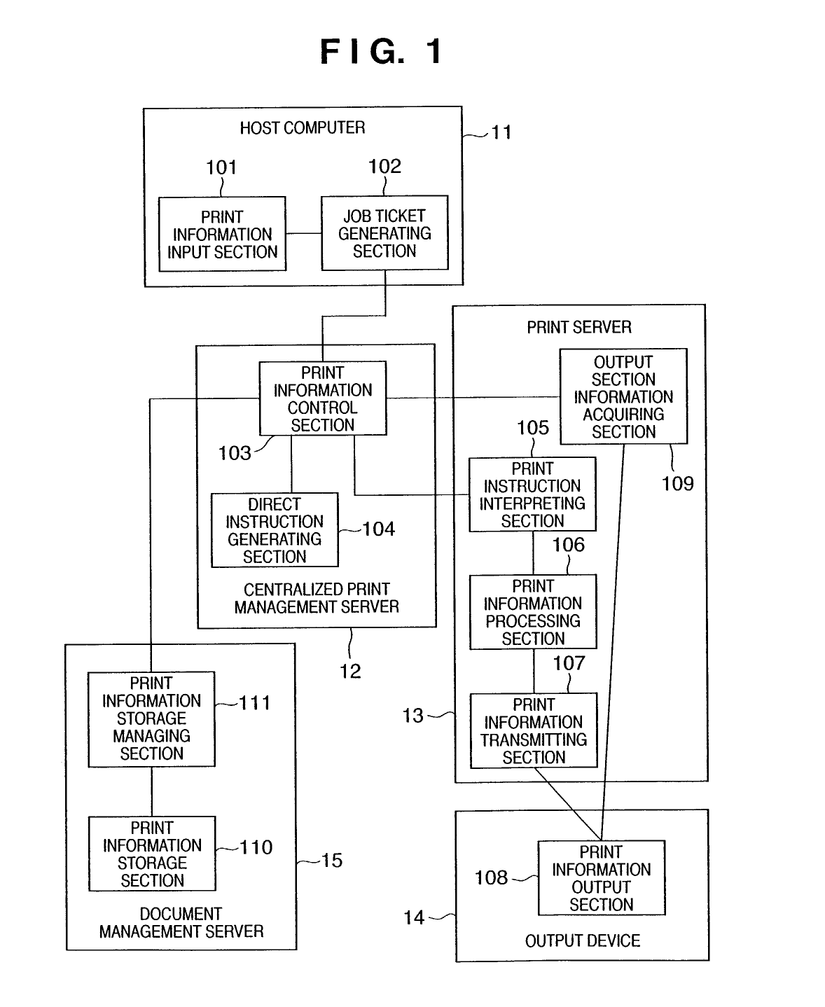

FIG. 1 is a block diagram showing the arrangement of a print system according to the first embodiment. Referring to FIG. 1, a print information input section 101 inputs print information containing print data as a print original and a print instruction which instructs the type of printing. A job ticket generating section 102 generates a job ticket from a print instruction. The print information input section 101 and job ticket generating section 102 are included in a host computer 11. A print information control section 103 controls a print system on the basis of print information containing one set of the job ticket and print data. A direct instruction generating section 104 generates a direct instruction different from the job ticket on the basis of the instruction of the job ticket. The print information control section 103 and direct instruction generating section 104 are included in a centralized print management server 12.

A print instruction interpreting section 105 interprets the direct instruction and job ticket. A print information processing section 106 processes the print information on the basis of the interpret result of the print instruction interpreting section 105 and prepares for output. A print information transmitting section 107 transmits the print information processed by the print information processing section 106 to an output device such as a printer. An output section information acquiring section 109 acquires information such as the operation situation of an output device (14). The print instruction interpreting section 105, print information processing section 106, print information transmitting section 107, and output section information acquiring section 109 are included in a print server 13.

A print information output section 108 is included in the output device 14 such as a printer. A print information storage section 110 stores print information containing one set of a job ticket and original data. A print information storage managing section 111 manages the print information storage section 110. The print information storage section 110 and print information storage managing section 111 are included in a document management server 15. Note that the document management server 15 is used in the second embodiment to be described later. In the arrangement shown in FIG. 1, the devices 11 to 15 are separate devices connected through a network. However, for example, the centralized print management server 12 and print server 13 may be implemented by a single device. Alternatively, the host computer 11, centralized print management server 12, print server 13, and document management server 15 may be implemented by a single device.

In the first embodiment, as a detailed example, assume that in a system which executes printing by selecting one of four printers on a network, a trouble occurs in printing by a first candidate printer, and substitute printing is executed by a second candidate printer. In this embodiment, assume that four printers (four output devices 14) are connected to the print server 13.

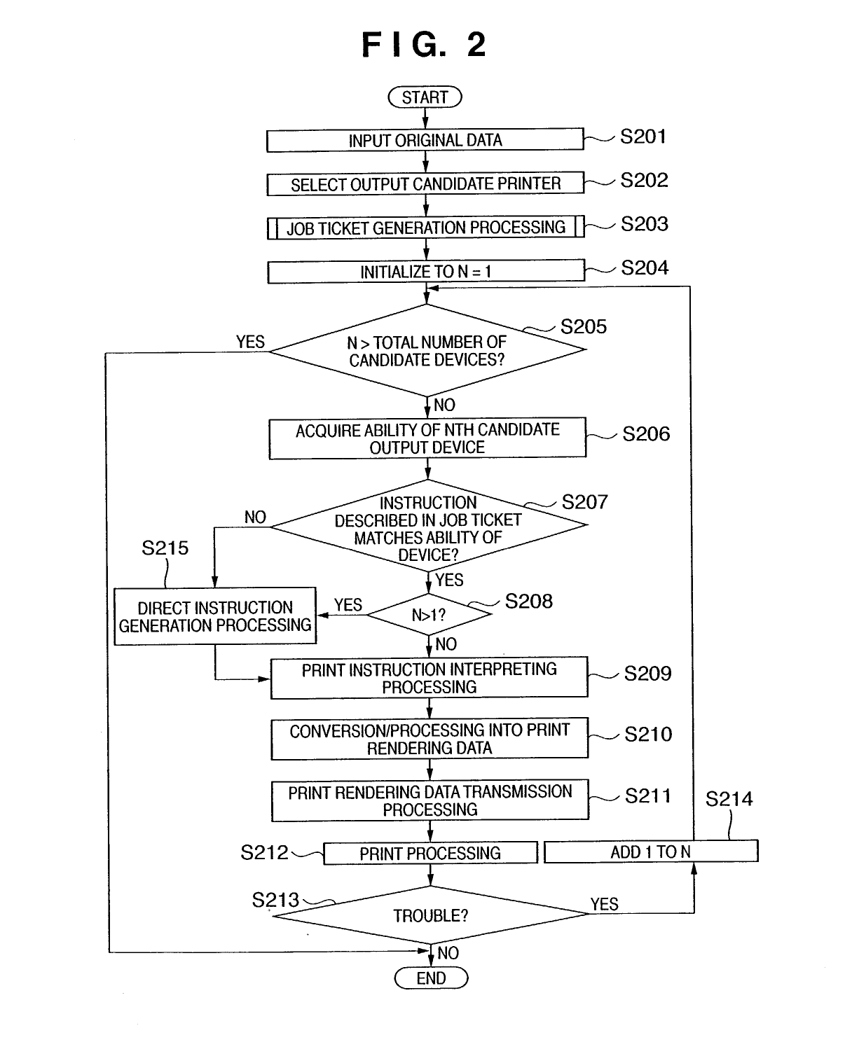

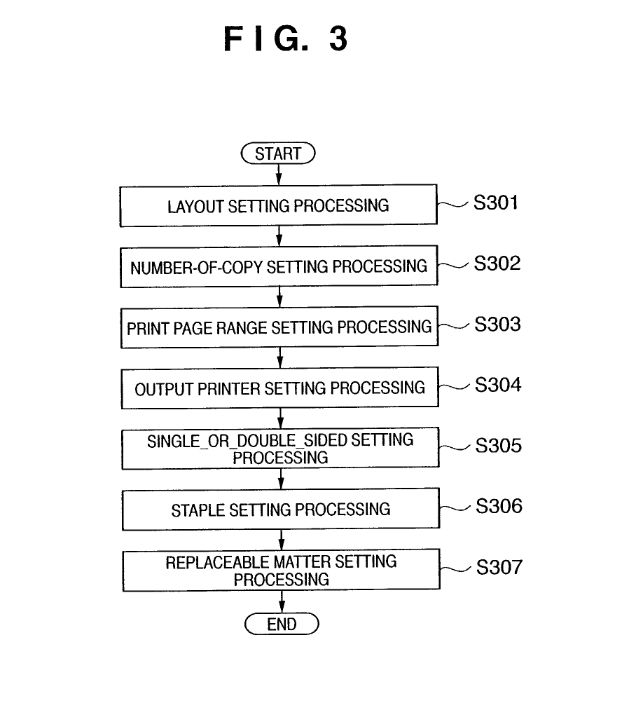

The flow of processing will be described next with reference to FIGS. 1 to 3. FIGS. 2 and 3 are flow charts for explaining print processing by the first embodiment.

First, in step S201, the print information input section 101 inputs print data and a print instruction as print information. An example of print data is a PDF (Portable Document File). The print instruction contains the number of copies, paper size, various finishing forms, single_or_double-sided printing, Number-Up (the number of print pages per sheet; to be referred to as N-Up hereinafter), enlargement/reduction, and print page designation (a page to be printed is designated). In addition, the print information input section 101 selects output candidate printers (step S202).

In this embodiment,

first priority printer=Printer-A,

third priority printer=Printer-B,

fourth priority printer=Printer-C, and

second priority printer=Printer-D are selected and set as candidates.

Note that setting of the priorities of a plurality of printers is realized using a user interface (not shown) on the host computer 11. To realize such setting, a graphical user interface (GUI) is generally used.

In step S203, the job ticket generating section 102 generates a job ticket from the print information containing the number of copies, paper size, staple, color printing, single_or_double-sided printing, N-Up, enlargement/reduction, and print page designation, and the output candidate printers.

FIG. 3 is a flow chart showing job ticket generation processing. In layout setting processing in step S301, layout-related setting for, e.g., the N-Up, enlargement/reduction, and paper size is done. In number-of-copies setting processing in step S302, the number of copies to be printed is set. In print page range setting processing in step S303, the print page is set. In output printer setting processing in step S304, the output candidate printers selected in step S202 are set. In single_or_double-sided printing setting processing in step S305, single_or_double-sided printing is set. In staple setting processing in step S306, whether stapling is to be executed is set. In replaceable matter setting processing in step S307, replaceable processing in substitute printing is set. Various settings above are done by the host computer 11 through a GUI (not shown).

Note that “replaceable processing” means that if a printer that should execute substitute printing cannot execute processing instructed by a job ticket, the processing is replaced. For example, when double-sided printing is instructed, and the substitute printer has no double-sided printing function, the printer is permitted to execute single-sided printing. In the following description, “single-sided printing” is set as “replaceable processing”. However, the present invention is not limited to this. In addition, a plurality of kinds of processing (e.g., “single-sided printing” and “staple”) may be designated as “replaceable processing”, as is apparent for those who skilled in the art.

A detailed example of part of a thus generated job ticket will be described below. The following XML description indicates an example of part of a job ticket in which the set result of the output devices 14 and part of a print instruction are set most simply.

<instruction_part>

<substitute-related_instruction automatic_{—}

substitute=ON number_of_member_printers=4>

<member_parameter priority_order=1>

<printing_device_information

device_name=Printer-A/>

K/member_parameter>
<member_parameter priority_order=2>

<printing_device_information

device_name=Printer-D/>

</member_parameter>
<member_parameter priority_order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<output_control_detail_parameters

number_of_copies=“90”
NumberUp=“4in1”
print_range=“1 ˜ 100”
single_or_double-sided=“double-sided”
staple=“upper left”
replaceable_matter=″
single_or_double-sided″
printing_device=“Printer-A”/>

</output_control_instruction>

</instruction part>

Processing in the host computer 11 has been described above. Next, the generated job ticket is sent to the print information control section 103 in the centralized print management server 12. The print information control section 103 controls the print system on the basis of the received job ticket. In this example, in step S204, a variable N representing the candidate printer order is initialized to 1. The variable N and the total number of candidate printers (the number of member printers) are compared. In step S205, if the variable N is larger than the total number of candidate printers, the processing is ended. In this example, since N=1 at this time, the variable N is smaller than the total number of candidate printers (=4). Hence, the flow advances to step S206.

In step S206, the print information control section 103 acquires the ability of the first candidate output printer through the output section information acquiring section 109. In step S207, it is checked whether the instruction described in the job ticket matches the ability of the first candidate output printer. If YES in step S207, it is also checked in step S208 whether the variable N is equal to or larger than 2 (i.e., whether the candidate priority order of the printer to be used is 2 or less).

When the instruction described in the job ticket matches the ability of the output printer, and N=1, i.e., the first candidate printer is used, the job ticket is sent to the print instruction interpreting section 105 in the print server 13 without being changed. The print instruction interpreting section 105 interprets the job ticket (step S209). The print information processing section 106 executes conversion/processing into print rendering data using the interpret result (step S210) to generate print rendering data and printer control data.

In step S211, the print information transmitting section 107 transmits the print rendering data printer control data to the print information output section 108 in the output device 14. In step S212, the print information output section 108 executes print processing by the printer. If the print processing is ended without any trouble, the processing is ended from step S213.

If a trouble has occurred in the print processing in step S212, the print information output section 108 notifies the output section information acquiring section 109 of it. The information is also sent to the print information control section 103 by the output section information acquiring section 109. In this case, the print information control section 103 operates to select the next candidate printer and execute substitute printing.

More specifically, the flow advances from step S213 to step S214 to add 1 to the variable N representing the candidate printer priority order. In this case, since the printer priority order with the trouble is 1 (N=1), N=2.

Next, the variable N is compared with the total number of candidate printers. If the variable N is larger than the total number of candidate printer in step S205, the processing is ended. In this case, since N=2, the variable N is equal to or smaller than the total number of candidate printer (=4). Hence, in step S206, the ability of the second candidate output printer is acquired through the output section information acquiring section 109.

In step S207, it is checked whether the instruction described in the job ticket matches the ability of the second candidate output printer. If YES in step S207, it is also checked in step S208 whether the variable N is 2 or more, i.e., the candidate priority order of the printer to be used is 2 or less. In this case, since the second candidate printer is selected as the output device 14, N>1, and the flow advances to step S215 because an instruction to change the printing device must be generated.

In step S215, the direct instruction generating section 104 generates a direct instruction to select the second candidate printer as the output device 14. For example, a direct instruction containing information

printing_device=“Printer-D”

is generated. This direct instruction is sent to the print instruction interpreting section 105 together with the job ticket. Except for the information as the direct instruction, setting information described in the job ticket is continuously used.

The print instruction interpreting section 105 interprets the received job ticket and direct instruction (step S209). The print information processing section 106 executes conversion/processing into print rendering data using the interpret result to generate print rendering data and printer control data (step S210). In step S211, the print information transmitting section 107 transmits the print rendering data printer control data to the print information output section 108. The print information output section 108 executes print processing by the printer, i.e., the output device 14, by the received print rendering data and printer control data (step S212).

If the instruction in the job ticket does not match the ability of the first candidate (or second candidate) output printer in step S207 (for example, if the printer cannot execute double-sided printing), the direct instruction generating section 104 generates a direct instruction according to the lack of ability of the printer to change the processing to processing based on the replaceable processing setting (e.g., “if double-sided printing is impossible, single-sided printing is performed”) defined in advance (step S215).

For example, in the above example (N=2 and NO in step S207), a direct instruction containing information

printing_device=“Printer-D”

single_or_double-sided=“single-sided”

is generated and sent to the print instruction interpreting section 105 together with the job ticket.

Upon receiving the job ticket with the direct instruction, the print instruction interpreting section 105 interprets the job ticket and direct instruction (step S209). The print information processing section 106 executes conversion/processing into print rendering data using the interpret result (step S210) to generate print rendering data and printer control data. In step S211, the print information transmitting section 107 transmits the print rendering data and printer control data generated in step S210 to the print information output section 108. The print information output section 108 executes print processing by the printer, i.e., the output device 14 using these data (step S212).

As described above, according to the first embodiment, substitute printing by a device having a different ability can be executed by introducing replaceable processing. Hence, the user can give a priority over a desired device that should execute substitute printing. That is, no usable devices need be limited in the system, and printing can more conveniently be executed in the network.

If a lack has occurred in a function that is not set as an object of replaceable processing, the setting can be regarded as irreplaceable, and an error interrupt can be executed. For example, only “single_or_double-sided” is set as replaceable processing, and a printer having no staple function is selected, the setting is regarded as irreplaceable, and an error interrupt occurs. With this arrangement, any print output unwanted by the user can be prevented.

<Second Embodiment>

In the first embodiment, when the first candidate printer cannot print due to some trouble, a substitute printer is used for printing. In the second embodiment, instead, printing can be performed again when the first candidate printer is restored later.

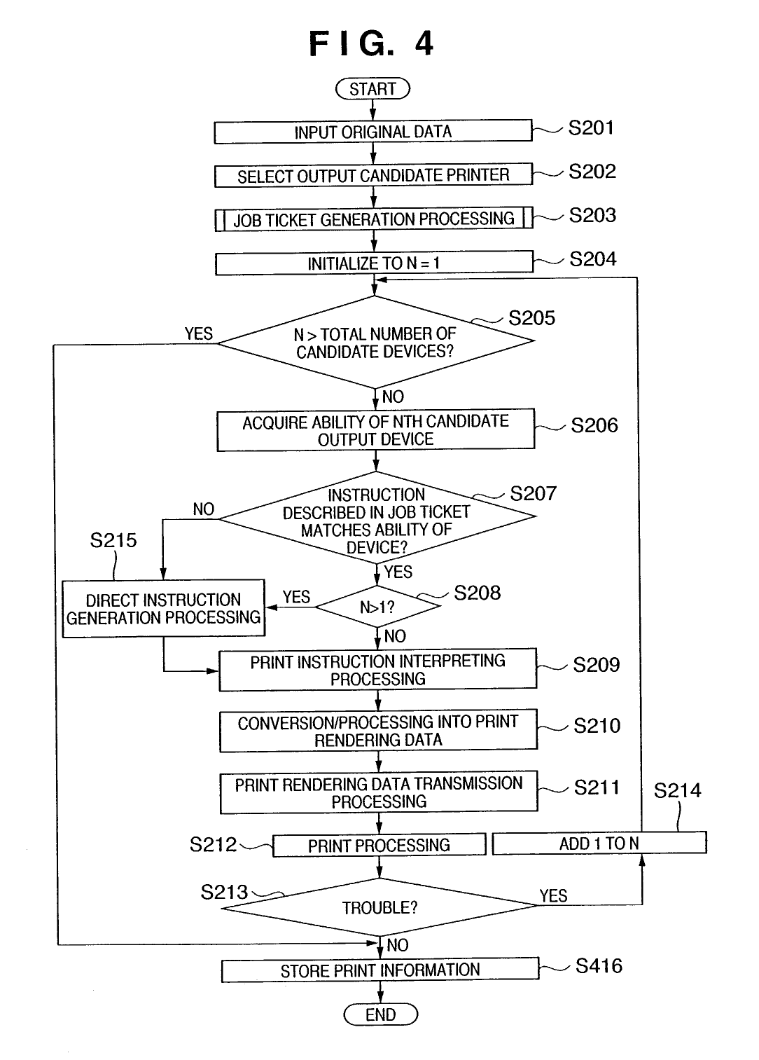

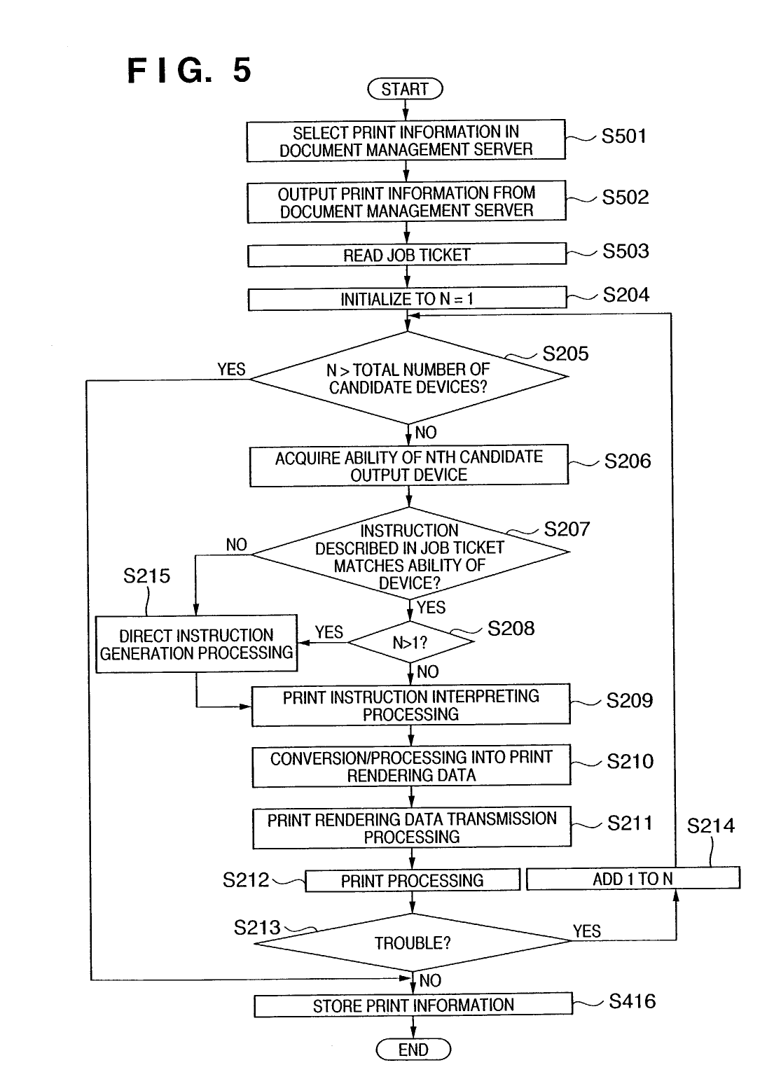

The print system of the second embodiment is the same as that of the first embodiment (FIG. 1) except that a job ticket and print data (i.e., a print job) to be printed again are stored and managed by a document management server 15. Processing of the second embodiment will be described below with reference to the flow charts of FIGS. 4 and 5.

In the second embodiment as well, as a detailed example, assume that in a system which executes printing by selecting one of four printers on a network, a trouble occurs in printing by a first candidate printer, and substitute printing is executed by a second candidate printer, as in the first embodiment.

The same step numbers as in FIG. 2 denote the same processes in FIG. 4. Points different from FIG. 2 will be described. When a variable N exceeds the total number of candidate devices in step S205, or printing is ended without any trouble in step S213, step S416 is executed instead of ending the processing. In step S416, a print information storage managing section 111 stores the print data and a job ticket representing a print instruction in a print information storage section 110 as print information. After storage is ended, the printing is ended. That is, a job ticket, whose detailed example has been partially described in the first embodiment, which is generated in step S203 is stored in the print information storage section 110.

Operation of printing the thus stored print information again will be described next with reference to the flow chart of FIG. 5. First, in step S501, desired print information is selected from print information stored in the print information storage section 110 in the document management server 15. In step S502, the print information selected using a host computer 11 is output to a print information control section 103 by the print information storage managing section 111. That is, the print information storage managing section 111 outputs to the print information control section 103 the print data and job ticket stored in step S416 in FIG. 4. The print information control section 103 reads a print instruction from the print data and job ticket as received print information and controls the print system (step S503). A subsequent control procedure is the same as in steps S204 to S215 in FIG. 4, and a description there of will be omitted.

As described above, according to the second embodiment, print information with a job ticket can be reused.

<Third Embodiment>

In the first and second embodiments, when a printer has no function designated in a job ticket, a direct instruction is generated on the basis of a replaceable matter described in the job ticket to make the print system to continue the print processing. In the third embodiment, the job ticket is updated instead of generating a direct instruction.

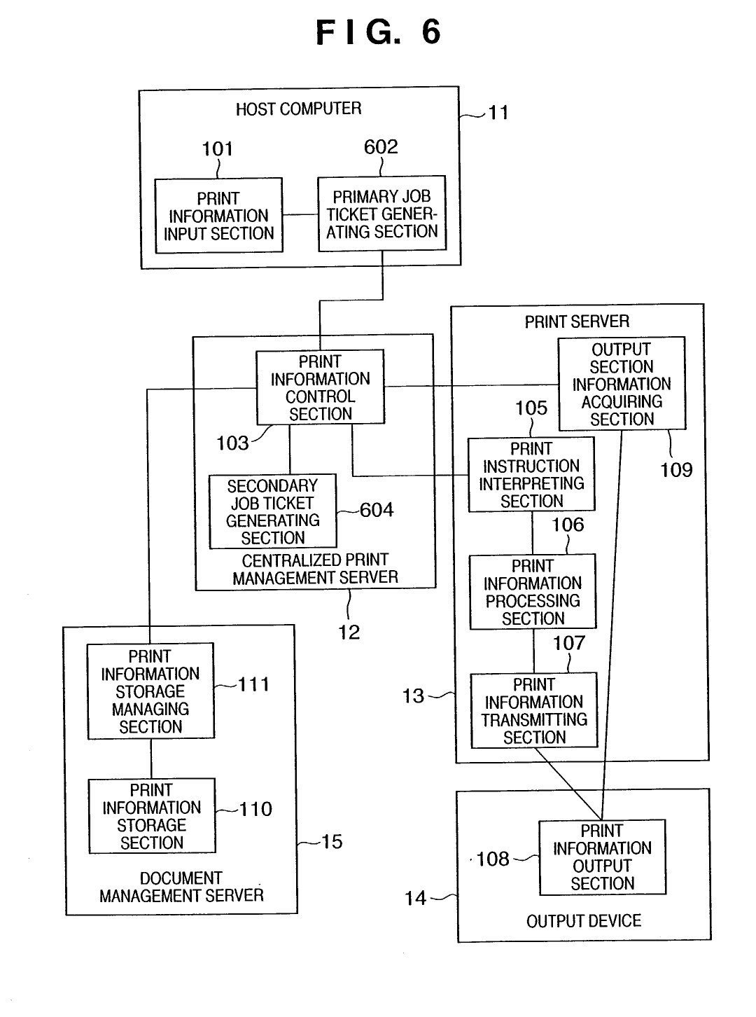

FIG. 6 is a block diagram showing the arrangement of the print system according to the third embodiment. The same reference numerals as in FIG. 1 denote the same components in FIG. 6, and a detailed description thereof will be omitted. FIG. 6 is different from FIG. 1 in a centralized print management server 12 has a secondary job ticket generating section 604 in place of a direct instruction generating section 104. The secondary job ticket generating section 604 generates a new job ticket by partially or wholly changing a job ticket. For example, when substitute printing occurs or processing based on a replaceable matter occurs, the job ticket is updated to generate a new job ticket. Details of this operation will be apparent from the description of the operation later. A primary job ticket generating section 602 in a host computer 11 has the same function as that of the job ticket generating section 102 shown in FIG. 1.

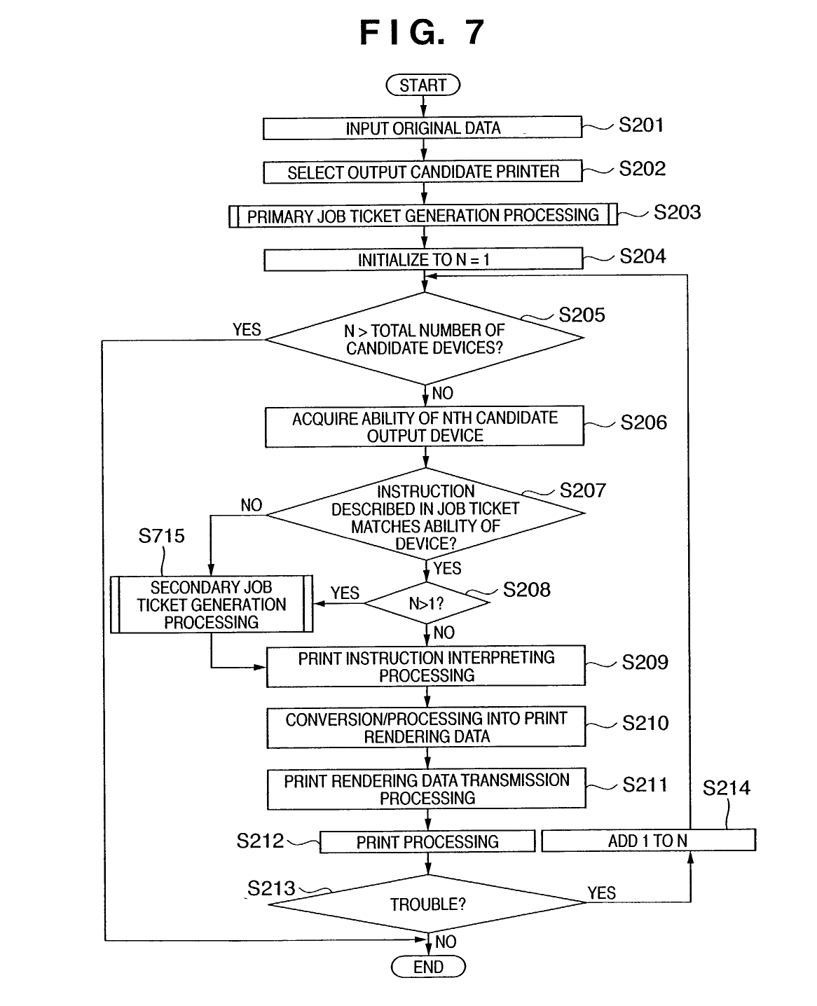

FIG. 7 is a flow chart for explaining print processing by the third embodiment. The same step numbers as in the first embodiment (FIG. 2) denote the same processing steps in FIG. 7. In step S203, a job ticket is generated by the primary job ticket generating section 602. The processing contents are the same as described in the first embodiment with reference to FIG. 3.

In step S715, processing of causing the secondary job ticket generating section 604 to generate (update) a job ticket when it is determined in step S207 that an instruction described in the job ticket does not match the ability of a device or it is determined in step S208 that the candidate priority order of the printer that is currently being used is 2 or less.

For example, in a case wherein print data is being processed by a job ticket described in the first embodiment, if 30 copies have been printed by the first candidate printer, and a trouble has occurred in the 31st and subsequent copies, the flow advances from step S213 to step S214 to add 1 to a variable N. Since N(=2)>1, step S715 is executed after steps S205 to S208.

In this case, the secondary job ticket generating section 604 generates the following job ticket.

<recording_part>

<substitute-related_instruction

automatic_substitute=ON number_of_member printers=4>

<member_parameter number_of_copies=30

priority_order=1>

<printing_device_information

device_name=Printer-A/>

</member_parameter>
<member_parameter priority_order=2>

<printing_device_information

device_name=Printer-D/>

</member_parameter>
<member_parameter priority_order=3>

<printing_device_information

device_name=Printer-B/>

</member_parameter>
<member_parameter priority_order=4>

<printing_device_information

device_name=Printer-C/>

</member parameter>

</substitute-related_instruction>
<output_control_instruction>

<detail_parameters

number_of_copies=“90”
NumberUp=“4in1”
print_range=“1 ˜ 100”
single_or_double-sided=“double-sided”
staple=“upper left”
replaceable_matter=“
single_or_double-sided”/>

</output_control_instruction>

</recording part>
<instruction_part>

<substitute-related_instruction

automatic_substitute=ON number_of_member_printers=4>

<member_parameter number_of_copies=30

priority_order=1>

<printing_device_information

device_name=Printer-A/>

</member_parameter>
<member_parameter priority order=2>

<printing_device_information

device_name=Printer-D/>

</member_parameter>
<member_parameter priority order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<detail_parameters

number_of_copies=“60”
NumberUp=“4in1”
print_range=“1 ˜ 100”
single_or_double-sided=“double-sided”
staple=“upper left”
replaceable_matter=″
single_or_double-sided″

</output_control_instruction>

</instruction_part>

As described above, the job ticket has a recording part sandwiched between <recording_part> and <recording_part> to store the first job ticket and also information representing that only 30 copies are printed for the first candidate printer.

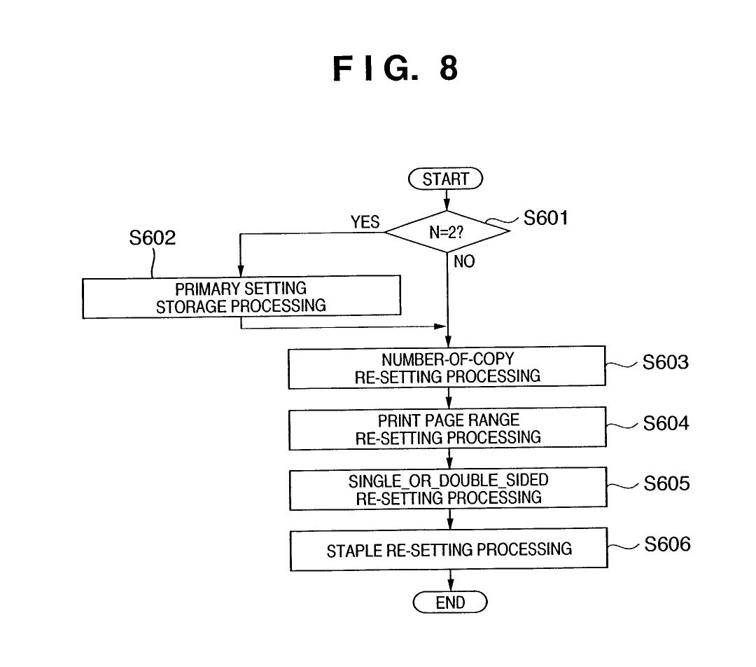

FIG. 8 shows secondary job ticket generation processing. In step S601, when N=2, i.e., when a job ticket for output to the second candidate printer is to be generated, the flow advances to step S602. In step S602, a recording part (a portion sandwiched between <recording_part> and </recording_part>) is formed in the job ticket, and the job ticket in the initial state is stored in this recording part. Otherwise, only a portion that has changed in the subsequent setting processing is added to the recording part.

In number-of-copies re-setting processing in step S603, the number of copies is re-set. In this processing, the number of copies processed by the used printer is stored. In the above example, number of copies=30 is added to the member parameter of Printer-A in the recording part and instruction part. In addition, the number of copies in the detail parameters of the instruction part is set to 90−30 =60. The “number_of_copies=30” in the instruction part is the same as “number_of_copies=30” in the recording part and may therefore be omitted.

In steps S604 to S606, the print range (print page range), single_or_double-sided, and staple in the detail parameters are re-set. More specifically, the print page range is re-set by print page re-setting processing in step S604, single_or_double-sided is re-set by single_or_double-sided re-setting processing in step S605, and stapling is re-set by staple re-setting processing in step S606. The job ticket generated by the secondary job ticket generating section 604 is sent to a print instruction interpreting section 105.

The print instruction interpreting section 105 interprets the job ticket instep S209. A print information processing section 106 executes conversion/processing into print rendering data using the interpret result (step S210) to generate print rendering data and printer control data. In this case, the information in the recording part indicates that the print result by the first candidate printer is number of copies=30. Hence, printer control data for the second candidate printer (Printer-D) is generated for the remaining number of copies (60).

In step S211, a print information transmitting section (107) transmits the print rendering data printer control data to a print information output section (108). The print information output section (108) executes print processing by the printer as the output device.

Even if the instruction described in the job ticket does not match the ability of the first candidate output printer in step S207 (for example, when the printer cannot execute double-sided printing), a secondary job ticket is generated in step S715. In this case, the secondary job ticket generating section 604 generates a job ticket whose processing contents are changed according to the lack of ability of the printer on the basis of the replaceable setting matter (e.g., “if double-sided printing is impossible, single-sided printing is performed”) defined in advance (S215).

For example, the first candidate printer did not print at all, and substitute printing is to be executed using the second candidate printer which has no double-sided printing function, the following job ticket is generated in step S715.

That is,

<recording_part>

<substitute-related_instruction

automatic_substitute=ON number_of_member_printers=4>

<member_parameter number_of_copies=0

priority_order=1>

<printing_device_information

device_name=Printer-A/>

</member_parameter>
<member_parameter priority_order=2>

<printing_device_information

device_name=Printer-D/>

>/member_parameter>
<member_parameter priority_order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<detail_parameters

number_of_copies=“90”
NumberUp=“4in1”
print_range=“1 ˜ 100”
single_or_double-sided=“double-sided”
staple=“upper left”
replaceable_matter=″
single_or_double-sided″/>

</output_control_instruction>

</recording_part>
<instruction_part>

<substitute-related_instruction

automatic_substitute=ON number_of_member_printers=4>

<member_parameter number_of_copies=0

priority_order=1>

<printing_device_information

device_name=Printer-A/>

</member_parameter>
<member_parameter priority_order=2>

<printing_device_information

device_name=Printer-D/>

</member_parameter>
<member_parameter priority_order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<detail_parameters

number_of_copies=“90”
NumberUp=“4in1”
print_range=“1 ˜ 100”
single_or_double-sided=“single-sided”
staple=“upper left”
replaceable_matter=″
single_or_double-sided″

</output_control_instruction>

</instruction_part>

At this time, pieces of information representing that printing was not performed by the first candidate printer and that the initial output control instruction was double-sided printing are stored in the recording part of the job ticket. In the instruction part, single_or_double-sided=“single-sided” is set in accordance with the set contents of the replaceable matter and the fact that the second candidate printer has no double-sided printing function. In this case, the information in the recording part indicates that the print result by the first candidate printer is number_of_copies=0. Hence, printer control data for the second candidate printer (Printer-D) is generated such that the remaining number of copies (90) are printed in the “single-sided” mode.

As described above, according to the third embodiment, instead of generating a direct instruction described in the first embodiment, printing is controlled by changing the description of a job ticket. The job ticket has a recording part in which original instruction parameters, the number of copies, and the printer that printed the copies are recorded. Hence, the recording situation can be conveniently grasped.

<Fourth Embodiment>

In the third embodiment above, when the first candidate printer cannot print information due to some trouble, the job ticket is updated, and the second candidate printer executes printing. In the fourth embodiment, print data and a job ticket are stored such that the data can be printed again when the first candidate printer is restored later.

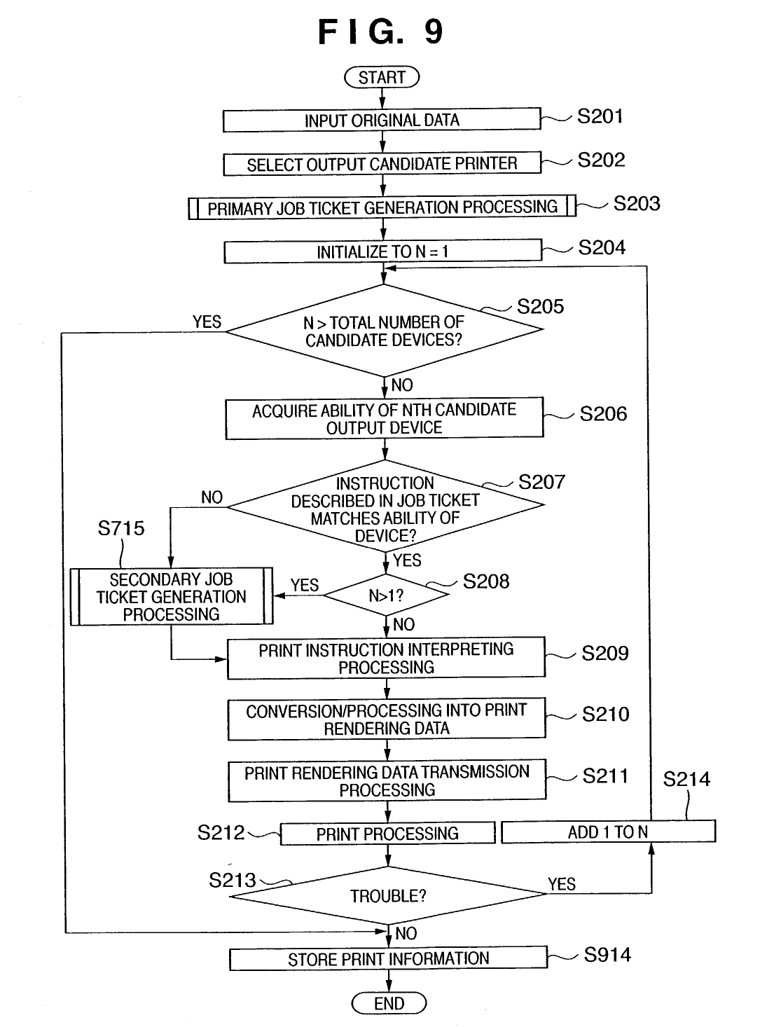

The print system of the fourth embodiment is the same as that of the third embodiment (FIG. 1) except that a job ticket for printing data again is stored and managed by a document management server 15. Processing of the fourth embodiment will be described below with reference to the flow charts of FIGS. 9 to 11.

In the fourth embodiment as well, as a detailed example, assume that in a system which executes printing by selecting one of four printers on a network, a trouble occurs in printing by a first candidate printer, and substitute printing is executed by a second candidate printer, as in the first embodiment.

The same step numbers as in FIG. 7 denote the same processes in FIG. 9. Points different from FIG. 7 will be described. When a variable N exceeds the total number of candidate devices in step S205, or printing is ended without any trouble in step S213, step S914 is executed instead of ending the processing. In step S914, a print information storage managing section 111 stores the print data and a job ticket used for it in a print information storage section 110 as print information. After storage is ended, the printing is ended. That is, a job ticket which is generated in step S203 and updated in step S715 as needed is stored in the print information storage section 110.

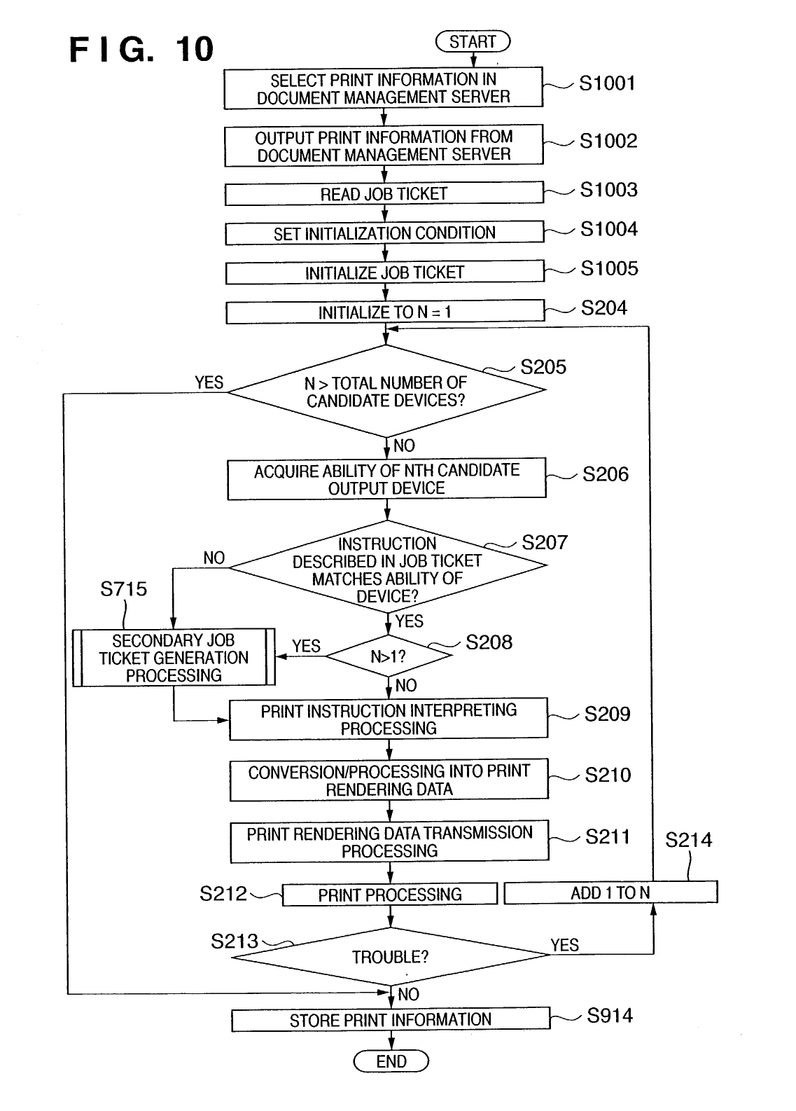

Printing data again will be described next with reference to the flow chart of FIG. 10.

First, in step S1001, desired print information is selected from print information stored in the document management server 15. In step S1002, the print information selected using a host computer 11 is output to a print information control section 103 by the print information storage managing section 111. In step S1003, the print information control section 103 reads a print instruction from the print data and job ticket as received print information and controls the print system.

For example, if 30 copies have been printed by the first candidate printer, and a trouble has occurred in the 31st and subsequent copies, the job ticket stored in step S914 in FIG. 9 is given as

<recording_part>

<substitute-related_instruction

automatic_substitute=ON number_of_member_printers=4>

<member_parameter number_of_copies=30

priority_order=1>

<printing_device_information

device_name=Printer-A/>

</member_parameter>
<member_parameter priority_order=2>

<printing_device_information

device_name=Printer-D/>

</member_parameter>
<member_parameter priority_order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<detail_parameters

number_of_copies=“90”
NumberUp=“4in1”
print_range=“1 ˜ 100”
single_or_double-sided=“double-sided”
staple=“upper left”
replaceable_matter=″
single_or_double-sided″/>

</output_control_instruction>

</recording_part>
<instruction_part>

<substitute-related_instruction

automatic_substitute=ON number_of_member_printers=4>

<member_parameter number_of_copies=30

priority_order=1>

<printing_device_information

device_name=Printer-A/>

</member_parameter>
<member_parameter priority_order=2>

<printing_device_information

device_name=Printer-D/>

</member_parameter>
<member_parameter priority_order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<detail_parameters

number_of_copies=“60”
NumberUp=“4in1”
print_range=“1 ˜ 100”
single_or_double-sided=“double-sided”
staple=“upper left”
replaceable_matter=″
single_or_double-sided″

</output_control_instruction>

</instruction_part>

Hence, in this case, the job ticket read in step S1003 has the same contents as described above.

In step S1004, an initialization condition whether data is to be printed again by the first candidate printer in accordance with the initial object of the job ticket or data is to be printed again by the first candidate printer from the substitute printing portion is selected. In step S1005, the read job ticket is initialized in accordance with the selection.

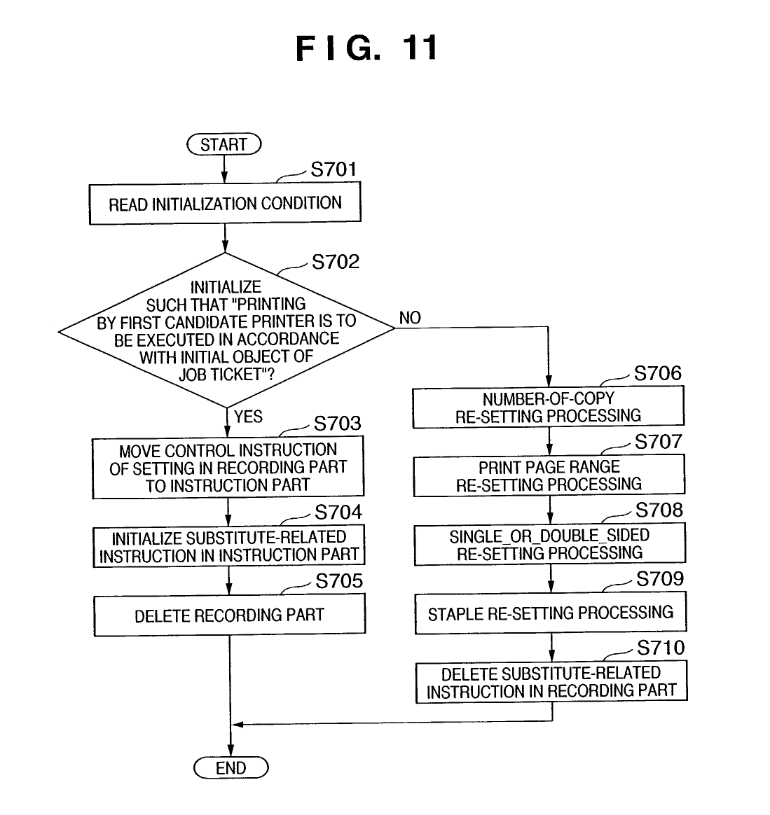

FIG. 11 shows job ticket initialization processing. In step S701, the initialization condition is read. The initialization condition is set by the user from the host computer. In step S702, processing is branched in accordance with the initialization condition. If the initialization condition is “printing is executed by the first candidate printer in accordance with the initial object of the job ticket”, the flow advances to step S703 to return the output control information recorded in the recording part of the job ticket is to the instruction part. In step S704, the number of copies is deleted by initializing the substitute-related instruction. In step S705, the recording part is deleted.

When “printing is executed by the first candidate printer in accordance with the initial object of the job ticket” is set in the above way, the job ticket is initialized in step S1005 such that “printing is executed by the first candidate printer in accordance with the initial object of the job ticket”.

In the following example, when 30 copies have been printed by the first candidate printer, and a trouble has occurred in the 31st and subsequent copies, the job ticket is initialized such that “printing is executed by the first candidate printer in accordance with the initial object of the job ticket”.

<instruction_part>

<substitute-related_instruction

automatic_substitute=ON number_of_member_printers=4>

<member_parameter priority_order=1>

<printing_device_information

device_name=Printer-A/>

</member_parameter>
<member_parameter priority_order=2>

<printing_device_information

device_name=Printer-D/>

</member_parameter>
<member_parameter priority_order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<detail_parameters

number_of_copies=“90”
NumberUp=“4in1”
print_range=“1 ˜ 100”
single_or_double-sided=“double-sided”
staple=“upper left”
replaceable_matter=″
single_or_double-sided″

</output_control_instruction>

</instruction_part>

Print processing is executed using the initialized job ticket in steps S204 to S214, S715, and S914. This processing is the same as that described with reference to FIG. 2, and a detailed description thereof will be omitted.

On the other hand, when “printing is executed from the substitute printing portion” is set in step S1004 as the job ticket initialization condition, processing is executed in the following manner in step S1005 (FIG. 11).

First, in step S701, the initialization condition is read. In this case, the condition is “printing is executed from the substitute printing portion”. Hence, the flow advances from step S702 to step S706. By number-of-copies re-setting processing in step S706, the number of copies in the output control instruction of the instruction part is returned to the initial state such that the remaining number of copies are printed from the output control information recorded in the recording part. By print gate range re-setting processing in step S707, the print page is re-set from the output control information recorded in the recording part. By single_or_double-sided setting processing in step S708, single_or_double-sided is re-set from the output control information recorded in the recording part. In staple re-setting processing in step S709, stapling is re-set for the output control information recorded in the recording part. In step S710, the substitute-related instruction in the recording part is deleted.

In the following example, when 30 copies have been printed by the first candidate printer, and a trouble has occurred in the 31st and subsequent copies, the job ticket is initialized such that “printing is executed from the substitute printing portion”.

<recording_part>

<output_control_instruction>

<detail_parameters

number_of_copies=“90”
NumberUp=“4in1”
print_range=“1 ˜ 100”
single_or_double-sided=“double-sided”
staple=“upper left”
replaceable_matter=″
single_or_double-sided″

</output_control_instruction>

</recording_part>
<instruction_part>

<substitute-related_instruction

automatic_substitute=ON number_of_member_printers=4>

<member_parameter priority_order=1>

<printing_device_information

device_name=Printer-A/>

</member_parameter>
<member_parameter priority_order=2>

<printing_device_information

device_name=Printer-D/>

</member_parameter>
<member_parameter priority_order=3>

<printing_device_information

device_name=Printer-B/>

</member_parameter>
<member_parameter priority_order=4>

<printing_device_information

device_name=Printer-C/>

</member_parameter>

</substitute-related_instruction>
<output_control_instruction>

<detail_parameters

number_of_copies=“60”
NumberUp=“4in1”
print_range=“1 ˜ 100”
single_or_double-sided=“double-sided”
staple=“upper left”
replaceable_matter=″
single_or_double-sided″

</output_control_instruction>

</instruction_part>

Print processing is executed using the initialized job ticket in steps S204 to S214, S715, and S914. This processing is the same as that described with reference to FIG. 2, and a detailed description thereof will be omitted.

As described above, according to the fourth embodiment, when data is to be printed again using a job ticket, whether printing is to be wholly re-executed from the beginning or only the remaining print pages that underwent substitute printing are to be printed can be selected. Hence, the flexibility in printing data again can be increased.

As described above, according to the above embodiments,

\mathring{1} By setting replaceable matters, substitute printing can be executed using devices having different abilities.

\mathring{2} Since each connected printer has a priority, the user can make a desired device to preferentially execute substitute printing.

\mathring{3} Usable devices need not be limited in the system.

\mathring{4} Convenience of printing or the like in the network can be increased.

\mathring{5} A plurality of devices can re-use one job ticket (conventionally, when a job ticket has a description depending on a device (printer) (e.g., the device name itself or a finishing function), the job ticket cannot be used for any purpose except an instruction for that device. However, when a plurality of candidate devices or replaceable matters are described in a job ticket, data can be printed again by a device with a name different from that of a device that has printed before storage, or printing by a device having a different ability also becomes possible).

The present invention may be applied to a system constituted by a plurality of devices (e.g., a host computer, an interface device, a reader, a printer, and the like) or an apparatus comprising a single device (e.g., a copying machine, a facsimile apparatus, or the like).

The object of the present invention is achieved even by supplying a storage medium which stores software program codes for implementing the functions of the above-described embodiments to the system or apparatus and causing the computer (or a CPU or MPU) of the system or apparatus to read out and execute the program codes stored in the storage medium.

In this case, the program codes read out from the storage medium implement the functions of the above-described embodiments by themselves, and the storage medium which stores the program codes constitutes the present invention.

As the storage medium for supplying the program codes, for example, a floppy disk, hard disk, optical disk, magnetooptical disk, CD-ROM, CD-R, magnetic tape, nonvolatile memory card, ROM, or the like can be used.

The functions of the above-described embodiments are implemented not only when the readout program codes are executed by the computer but also when the operating system (OS) running on the computer performs part or all of actual processing on the basis of the instructions of the program codes.

The functions of the above-described embodiments are also implemented when the program codes read out from the storage medium are written in the memory of a function expansion board inserted into the computer or a function expansion unit connected to the computer, and the CPU of the function expansion board or function expansion unit performs part or all of actual processing on the basis of the instructions of the program codes.

As has been described above, according to the present invention, substitute printing using devices having different abilities can be executed. In addition, since the use limitation of devices in the system is reduced, the devices on the network can efficiently be used.

As many apparently widely different embodiments of the present invention can be made without departing from the spirit and scope thereof, it is to be understood that the invention is not limited to the specific embodiments thereof except as defined in the claims.

What is claimed is:

1. A print system having a plurality of printers, comprising:
input means for inputting print data and a print instruction related to print control of the print data;
generation means for generating instruction information on the basis of the print instruction;
selection means for selecting one of the plurality of printers on the basis of the instruction information; and
change means for partially changing contents instructed by the instruction information if the selected printer cannot execute processing requested by the instruction information.

2. The system according to claim 1, wherein said change means generates a change instruction to change some of the contents instructed by the instruction information.

3. The system according to claim 1, wherein
the instruction information contains a priority order of the plurality of printers, and
said selection means selects the printer on the basis of the priority order.

4. The system according to claim 3, wherein
when a trouble has occurred during printing by the selected printer, said selection means selects a printer having a priority order next to the printer that is executing printing, and
said change means changes the instruction contents by the instruction information to execute print processing by the selected printer.

5. The system according to claim 1, wherein
the instruction information contains a designation of substitute processing to cope with inability of a printer, and
when the printer cannot execute processing requested by the instruction information, said change means partially changes the instruction contents by the instruction information on the basis of the designation of the substitute processing.

6. The system according to claim 1, further comprising
holding means for holding the print data and instruction information used for printing even after an end of the print processing, and
re-execution means for re-executing printing in accordance with the print data and instruction information held by said holding means.

7. The system according to claim 1, wherein
said change means generates changed instruction information which contains a description after update of the instruction information, a description before update of the instruction information, and a description representing a recording situation, and
the system further comprises
holding means for holding the print data and the changed instruction information even after an end of the print processing,
initialization means for initializing the changed instruction information held by said holding means on the basis of the descriptions before and after update and the description of the recording situation, and
re-execution means for executing printing in accordance with the print data held by said holding means and the instruction information obtained by said initialization means.

8. A print method using a plurality of printers, comprising:
the input step of inputting print data and a print instruction related to print control of the print data;
the generation step of generating instruction information on the basis of the print instruction;
the selection step of selecting one of the plurality of printers on the basis of the instruction information; and
the change step of partially changing contents instructed by the instruction information if the selected printer cannot execute processing requested by the instruction information.

9. The method according to claim 8, wherein in the change step, a change instruction to change some of the contents instructed by the instruction information is generated.

10. The method according to claim 8, wherein
the instruction information contains a priority order of the plurality of printers, and
in the selection step, the printer is printed on the basis of the priority order.

11. The method according to claim 10, wherein
in the selection step, when a trouble has occurred during printing by the selected printer, a printer having a priority order next to the printer that is executing printing is selected, and
in the change step, the instruction contents by the instruction information are changed to execute print processing by the selected printer.

12. The method according to claim 8, wherein
the instruction information contains a designation of substitute processing to cope with inability of a printer, and
in the change step, when the printer cannot execute processing requested by the instruction information, the instruction contents by the instruction information are partially changed on the basis of the designation of the substitute processing.

13. The method according to claim 8, further comprising
the holding step of holding the print data and instruction information used for printing even after an end of the print processing, and
the re-execution step of re-executing printing in accordance with the print data and instruction information held in the holding step.

14. The method according to claim 8, wherein
in the change step, changed instruction information which contains a description after update of the instruction information, a description before update of the instruction information, and a description representing a recording situation are generated, and
the method further comprises
the holding step of holding the print data and the changed instruction information even after an end of the print processing,
the initialization step of initializing the changed instruction information held in the holding step on the basis of the descriptions before and after update and the description of the recording situation, and
the re-execution step of executing printing in accordance with the print data held in the holding step and the instruction information obtained in the initialization step.

15. A computer-readable medium which stores a control program for causing a computer to execute print management, the print management processing executed by the control program comprising:
the input step of inputting print data and a print instruction related to print control of the print data;
the generation step of generating instruction information on the basis of the print instruction;
the selection step of selecting one of the plurality of printers on the basis of the instruction information; and
the change step of partially changing contents instructed by the instruction information if the selected printer cannot execute processing requested by the instruction information.
